(19) United States
(12) Patent Application Publication
(10) Pub. No.: US 2013/0068984 A1
(43) Pub. Date: Mar. 21, 2013

(54) AIR SHUTOFF SWING GATE VALVE

(71) Applicants: Kamyar Molavi, The Woodlands, TX (US); Ken McClymonds, The Woodlands, TX (US)

(72) Inventors: Kamyar Molavi, The Woodlands, TX (US); Ken McClymonds, The Woodlands, TX (US)

(73) Assignee: AMOT CONTROLS CORP., Houston, TX (US)

(21) Appl. No.: 13/274,636

(22) Filed: Oct. 17, 2011

Related U.S. Application Data
(63) Continuation-in-part of application No. 13/236,020, filed on Sep. 19, 2011.

(51) Int. Cl. F16K 3/00

(52) U.S. Cl. 251/336

(57) ABSTRACT

A swing gate valve is provided having a swing gate, a pivotable shaft having a swing arm disposed thereon such that rotation of the shaft causes rotation of the swing arm, a spring to urge the swing gate toward its closed position, a trigger assembly for securing the swing gate in its open position and for triggering the shaft to rotate including an actuator having a shaft and a receiver in the swing gate to receive the shaft, wherein when the shaft is in an extended position, the shaft is disposed in the receiver and the swing gate is locked in its open position, and wherein actuation of the actuator causes the shaft to withdraw to a retracted position out of the receiver, wherein the spring causes the pivotable shaft to rotate to move the swing gate to its closed position.

### CROSS-REFERENCE TO RELATED APPLICATION

This is a continuation-in-part application of U.S. patent application Ser. No. 13/236,020, filed Sep. 19, 2011, entitled Air Shutoff Swing Gate Valve.

### SPECIFICATION

### Background of the Invention

The present invention relates to an air shutoff valve, for example, to prevent uncontrolled runaway of the engine.

Diesel engines, in the presence of combustible gases in the atmosphere, occasionally enter a runaway condition in which the engine, without a proper device to mitigate this problem, can enter an uncontrolled acceleration. In this condition, the engine experiences overspeed and, if not stopped, the engine can reach speeds that can result in destruction and/or catastrophic engine failure, and personal injury. There are a number of causes of runaway including, for example, a faulty engine governor, engine overheating or the ingestion of unregulated hydrocarbons into the combustion chamber through the intake air. Such hydrocarbons may be from an external source such as airborne gas, or from the engine itself due to a malfunction such as failure of turbocharger oil seals.

A conventional way to stop a diesel engine is to stop the flow of fuel to the combustion chamber. However, an alternate method must be employed to stop a diesel engine in the event of runaway. The most common method, used for many years, involves blocking the air supply to the combustion chamber of the engine. Once deprived of oxygen, the runaway ceases. Accordingly, safety valves which cut off the air supply to the engine have been developed to shut off the engine in such a situation.

One type of shut-off valve placed in the air intake to the engine employs a swing gate valve that is spring biased to be in a closed position that blocks air supply to the combustion chamber. The spring loaded valve is held in an open position by a trip mechanism that is manually cocked to hold the valve in the open position. A solenoid or by other appropriate device may be used to trip the trip mechanism to close the valve. When in the open position, there is an unobstructed air supply to the engine. Upon runaway, the device is engaged (or disengaged), and the valve snaps into its closed position, thus cutting off the air supply to the combustion chamber, thereby starving the engine of oxygen such that the engine stalls.

Shutoff valves used in the past were susceptible to damage from high vibration loads and excessively high temperatures. The present invention provides improvements to past designs and provides a valve capable of experiencing higher vibration and temperature.

All references cited herein are incorporated herein by reference in their entireties.

### BRIEF SUMMARY OF THE INVENTION

An air shutoff swing gate valve is provided which includes a valve body having an air passage therein for supplying air and a valve swing gate pivotable on a swing arm that is pivotally disposed adjacent to the valve body. The swing gate is pivotable adjacent to the air passage from an open position wherein the swing gate is positioned adjacent to the air passage to provide for free flow of air through the air passage, to a closed position wherein the swing gate is positioned within the air passage to substantially close off the air passage. A pivotable shaft is provided that has a longitudinal axis extending perpendicular to the swing arm. The swing arm is disposed on the shaft such that rotation of the shaft about its longitudinal axis causes rotation of the swing arm to move the swing gate between its open and closed positions. A reset handle is disposed on the shaft, such that rotation of the reset handle to rotate the shaft causes the swing gate to move from its closed position to its open position. A spring rotationally biases the shaft about its longitudinal axis to urge the swing gate toward its closed position. A trigger assembly is provided for securing the swing gate in its open position and for triggering the shaft to rotate due to biasing from the spring to cause the swing gate to move from the open position to the closed position. The trigger assembly includes an actuator having an actuator shaft movable from an extended position to a retracted position, and a receiver in one of the swing arm and the swing gate to receive the actuator shaft. When the actuator shaft is in the extended position, the actuator shaft is disposed in the receiver and the swing gate is locked in its open position, and wherein actuation of the actuator causes the actuator shaft to withdraw to its retracted position out of the receiver, wherein the spring causes the pivotable shaft to rotate about its longitudinal axis to move the swing gate to its closed position.

The actuator may be mechanical, electro-mechanical, hydraulic, pneumatic, piezo, solenoid, or similar. The actuator may be disposed such that its actuator shaft is generally parallel to the swing arm when the swing gate is in its open and locked position such that the actuator shaft is disposed against the receiver on the swing arm to hold the swing gate in the open position. The actuator shaft of the swing arm may have a cam surface adapted to mate with a cam surface of the receiver. The receiver may be an aperture in the swing gate, wherein when the actuator shaft is in its extended position, the actuator shaft is disposed in the aperture to hold the swing gate in its open position. The actuator may be disposed such that its actuator shaft is generally perpendicular to the swing gate such that the actuator shaft is disposed against the receiver on the swing gate to hold the swing gate in the open position.

### BRIEF DESCRIPTION OF SEVERAL VIEWS OF THE DRAWINGS

The invention will be described in conjunction with the following drawings in which like reference numerals designate like elements and wherein:

FIG. 1 is a side, elevation view of an air shutoff swing gate valve in accordance with a first preferred embodiment of the present invention;

FIG. 2 is a simplified, cross-sectional view of the air shutoff swing valve of FIG. 1, taken substantially along lines II-II of FIG. 1;

FIG. 3 is a partial, isometric view of an actuation mechanism of the air shutoff swing gate valve for an engine of FIG. 1, shown with its cover removed for clarity;

FIG. 4 is a rear, elevation view of the air shutoff swing gate valve for an engine of FIG. 1, shown with the valve in its open position;

FIG. 5 is a front, elevation view of the actuation mechanism of the air shutoff swing gate valve for an engine of FIG. 1, shown with the valve in its open position, shown with its cover removed for clarity;

FIG. 6 is a rear, elevation view of the air shutoff swing gate valve for an engine of FIG. 1, shown with the valve in its closed position;

FIG. 7 is a front, elevation view of the actuation mechanism of the air shutoff swing gate valve for an engine of FIG. 1, shown with the valve in its closed position, shown with its cover removed for clarity;

FIG. 8 is a side, elevation view of an air shutoff swing gate valve for an engine in accordance with a second preferred embodiment of the present invention;

FIG. 9 is a rear, isometric view of the air shutoff swing gate valve for an engine of FIG. 8, shown with the valve in its closed position;

FIG. 10 is a rear, isometric view of the air shutoff swing gate valve for an engine of FIG. 8, shown with the valve in its open position;

FIG. 11 is an isometric view of an actuation mechanism of the air shutoff swing gate valve of FIG. 8;

FIG. 12 is a front isometric view of the actuation mechanism of FIG. 11, shown set for the valve to be in an open position, shown with its cover removed for clarity;

FIG. 13 is a front isometric view of the actuation mechanism of FIG. 11, shown set for the valve to be in a closed position, shown with its cover removed for clarity;

FIG. 14 is a simplified side, elevation view of an air shutoff swing gate valve in accordance with a third preferred embodiment of the present invention, shown with the swing gate in its closed position;

FIG. 15 is a simplified side, elevation view of the air shutoff swing gate valve of FIG. 14, shown with the swing gate in its open and locked position, prior to movement of the swing gate;

FIG. 16 is a simplified side, elevation view of the air shutoff swing gate valve of FIG. 14, shown with the swing gate open, but with its actuator in its released position, but prior to movement of the swing gate;

FIG. 17 is an isometric view of the air shutoff swing gate valve of FIG. 14;

FIG. 18 is a simplified side, elevation view of an air shutoff swing gate valve in accordance with a fourth preferred embodiment of the present invention, shown with the swing gate in its open and locked position, and shown with an alternate position of an actuator depicted in broken lines;

FIG. 19 is a partial, simplified side, elevation view of an air shutoff swing gate valve in accordance with a fifth preferred embodiment of the present invention, shown with the swing gate in its open and locked position;

FIG. 20 is a partial, simplified side, elevation view of the air shutoff swing gate valve of FIG. 19, shown immediately subsequent to release of the swing gate;

FIG. 21 is a simplified, side, elevation view of the air shutoff swing gate valve of FIG. 19, shown in its closed position;

FIG. 22 is a simplified, isometric view of an air shutoff swing gate valve in accordance with a sixth preferred embodiment of the present invention, shown with the actuator mounted in an alternate location;

FIG. 23 is a simplified isometric cutaway view of the air shutoff swing gate valve of FIG. 22, shown with the swing gate in its open and locked position;

FIG. 24 is a simplified isometric view of the air shutoff swing gate valve of FIG. 22, shown with the swing gate in its released position, but prior to full closure of the swing gate; and

FIG. 25 is a simplified isometric view of the air shutoff swing gate valve of FIG. 22, shown with the swing gate in its closed position.

### DETAILED DESCRIPTION OF THE INVENTION

The invention will be illustrated in more detail with reference to the following embodiments, but it should be understood that the present invention is not deemed to be limited thereto.

With respect to all embodiments described below, the present invention is directed to swing gate valve designs for use as an emergency diesel engine air shutoff swing gate valve. The embodiments are designed to operate over a wide range of on-engine intake air temperatures, ranging from about −40 degrees F. (−40 degrees C.) to about +600 degrees F. (+316 degrees C.), and elevated pressures (about 4 bar gauge) associated with, for example, post-turbocharger, pre-intercooler installation.

The valves provide a complete engine stop by providing an airtight shut-off to the intake manifold, achieved by use of a gate, which is attached to an actuating mechanism by an arm.

The swing gate valves are designed to be assembled as part of an intake manifold, for use as an emergency diesel engine air intake shutoff valve. The basic concept of the valve is that it has a manually latched gate held in the open (i.e., run) position by an actuation mechanism. The open position is defined as the gate being generally outside the intake airflow, allowing the free passage of intake air into the engine. The latched valve remains in the open position until such time as the valve is tripped, whereby the gate swings under the action of a spring into the closed position, blocking the air flow passage, and creating a generally airtight seal with the valve body. The restriction created by the closed valve fully throttles the engine, resulting in engine shutdown.

The designs are similar to an existing design by AMOT/RODA DEACO, such as Models 2190 and 2102, with enhancements for use over wider temperatures and pressures and with an improved, enclosed trigger mechanism. The trigger housing is sealed against both the environment and the charge air pressure.

The swing gate is preferably made from bronze. The gate is preferably loosely attached to the arm. There is substantially no possibility of fasteners working loose and entering the intake air stream of the engine. The gate is assembled to the gate arm via a pin, which is contained in place to ensure that it does not work loose.

Two seals are preferably used to prevent the charge air from leaking to the atmosphere or into the trigger housing as the shaft protrudes from the valve housing.

A separate actuation assembly, including the trigger assembly, is contained within a separate housing to the valve body in some embodiments. The trigger mechanism contains a cam and trigger arm that latch together when the gate is in the open position. The actuation assembly moving parts are connected to the gate via a linkage mechanism, which allows for manufacturing tolerances and ensures the gate is properly oriented in the open or closed position.

With respect to the embodiments of the present valve, electric actuation may be used. That is, preferably, an electronic solenoid provides the actuation force. In an alternate design the valve can trip upon loss of charge air pressure. Further, an air cylinder can be utilized as part of a pneumatic actuator to provide the tripping force. In any case, the mechanism is tripped and the spring provides the force to rotate the gate into the closed position once the cam and trigger arm are unlatched. The trigger mechanism also may incorporate a manual override button to manually trip the valve. The manual override button is present regardless of actuation type.

Various means of installing the air shutoff swing gate valve in place are possible, such as hump hoses or flanges (bolted, Marmon claims, etc.) by machining the appropriate geometry on the end connections of the appropriate body casting.

Embodiments of the present invention solve numerous problems, including, but not limited to, the following:
the valve is designed to operate over a wide range of on-engine intake air temperatures, ranging from −40 degrees F. (−40 degrees C.) to about +600 degrees F. (+316 degrees C.) and elevated pressures (up to 4 bar gauge) associated with, for example, post turbocharger, pre-intercooler installation;
the valve is designed to operate under the airflow rates for standard pipe sizes without any obstructions in the flow since the gate is outside the flowing air while the engine is in operation;
the trigger housing and valve body are sealed, utilizing gaskets and elastomeric seals;
the trigger mechanism requires a low actuation force to trip, thereby requiring only small pneumatic pressures, or small electric solenoid forces. This results in reduced valve weight and minimal envelope dimensions;
the use of a gate and arm that are loosely assembled together prevents the possibility of components working loose and entering the engine through the intake air stream;
use of stainless steel components allows the valve to be used in corrosive environments;
balance in system forces avoids the gate bouncing open on actuation, permitting undesired air flow to the engine;
the valve achieves a fully closed position in less than 1 second from receipt of a trip signal;
the design of the gate and shaft assembly parts to the valve body allows for no presence of vibration of the gate in the intake air stream, thereby minimizing the turbulence generation and resulting in stable engine operation; and
a vibration free reset handle and stop device allow for long lifetime, even in “hard” installations, with no hose connections.

The air shutoff swing gate valve of the present invention is designed to be assembled as part of the intake manifold of diesel engine. The basic concept of the valve is that it utilizes a manually latched gate held in the open (or run) position by an actuation trigger mechanism. The open or run position means that the swing gate allows for free passage of intake air into the engine. The latched valve remains in the open position until such time as the valve is tripped, whereby the swing gate rotates, under the action of a spring, creating an airtight seal with the valve body. The restriction created by the closed disc fully throttles the engine, resulting in an engine shut down.

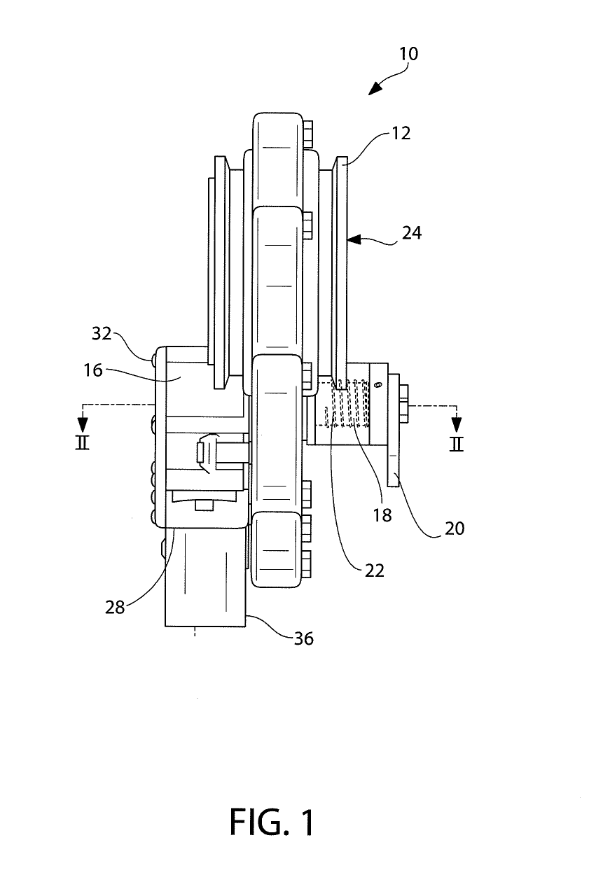

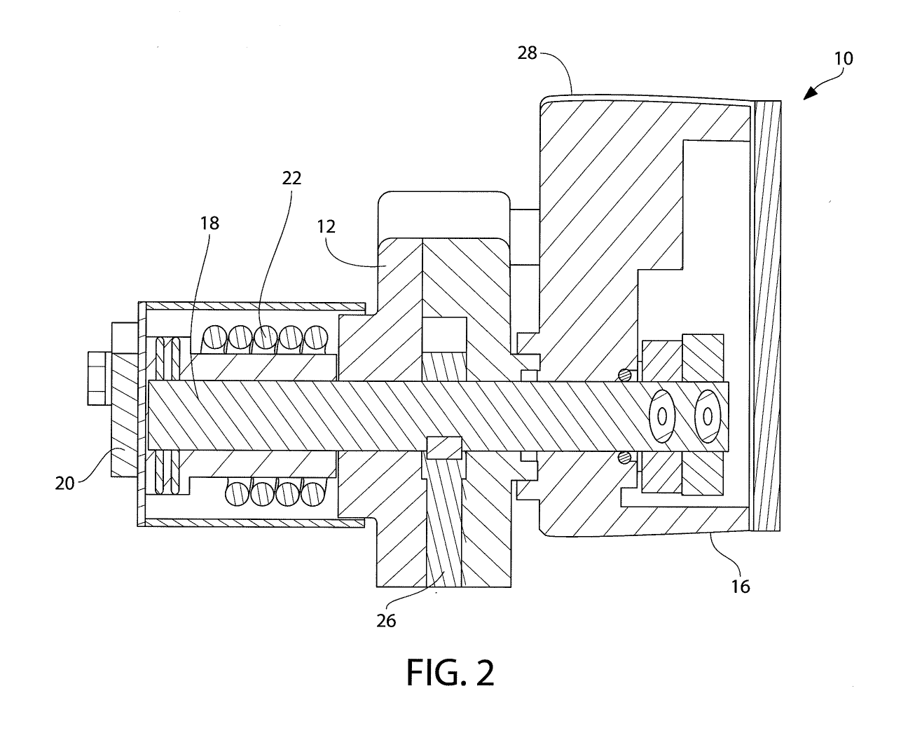

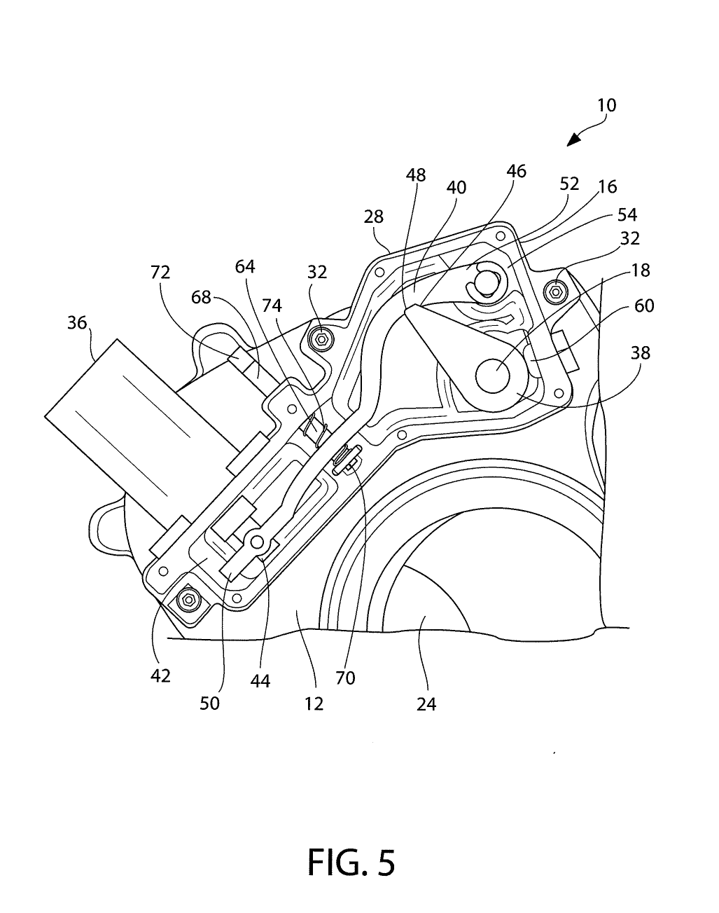

Referring now to the drawing figures, wherein like part numbers refer to like elements throughout the several views, there is shown in FIGS. 1-7 an air shutoff swing gate valve 10 for an engine in accordance with a first preferred embodiment of the present invention. The air shutoff swing gate valve 10 generally includes a valve body 12, a valve swing gate 14, an actuation assembly 16, a pivotable shaft 18, a reset handle 20, and a spring 22 (for example, a torsion spring, as shown).

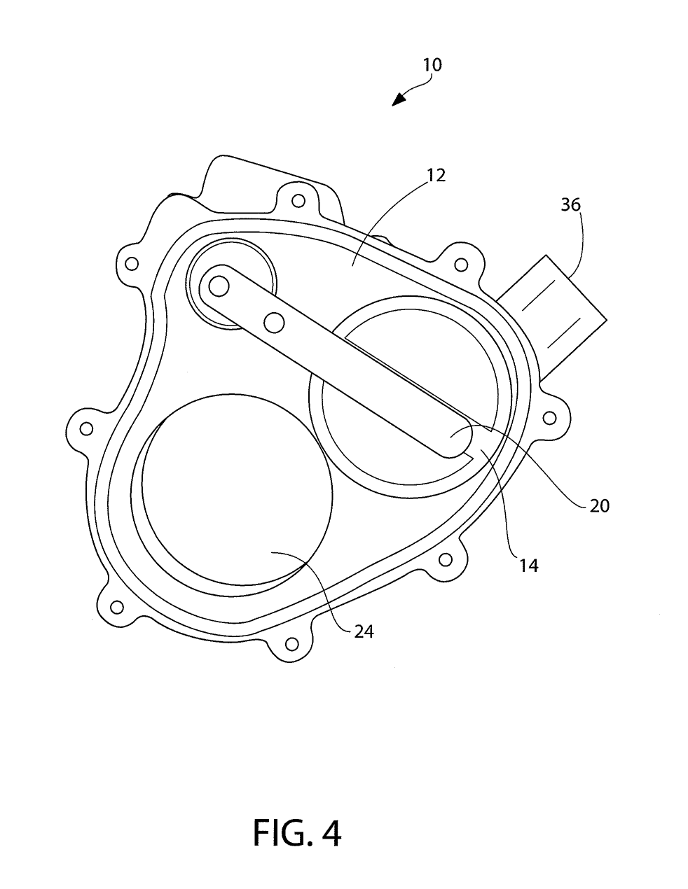

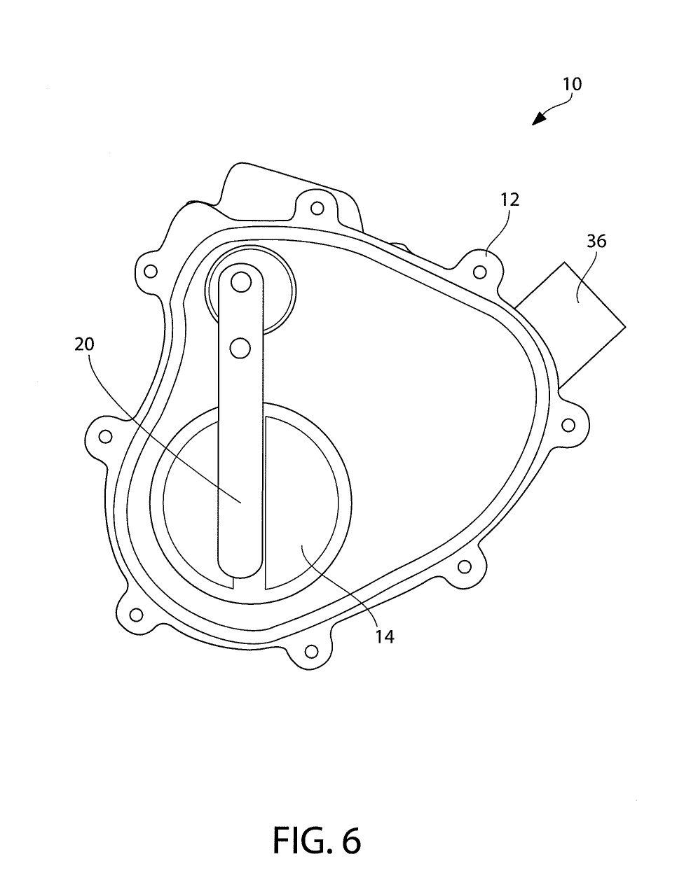

The valve body 12 has an air passage 24 therein for supplying air to an engine to which the air shutoff valve 10 is attached. The swing gate 14 is pivotable on a swing arm 26 that is pivotally disposed. The swing gate 14 is pivotable from an open position (see FIG. 4) wherein the swing gate 14 is positioned adjacent to the air passage 24 to provide for free flow of air through the air passage 24, to a closed position (see FIG. 6) wherein the swing gate 14 is positioned within the air passage 24 to substantially close off the air passage 24. The actuation assembly 16 includes an actuation housing 28 and a trigger assembly 30. The actuation housing 28 is preferably disposed on the valve body 12 by fasteners 32 (e.g. the threaded holes shown in combination with screws).

The pivotable shaft 18 has a longitudinal axis A (see FIG. 1) and extends from the actuation assembly 16 at least to the swing arm 26. The swing arm 26 is disposed on the shaft 18 such that rotation of the shaft 18 about its longitudinal axis A causes rotation of the swing arm 26 to move the swing gate 14 between its open (see FIG. 4) and closed positions (see FIG. 6). The reset handle 20 is disposed on the shaft 18 such that rotation of the reset handle 20 to rotate the shaft 18 causes the swing gate 14 to move from its closed position to its open position. The spring 22 rotationally biases the shaft 18 about its longitudinal axis A to urge the swing gate 14 toward its closed position.

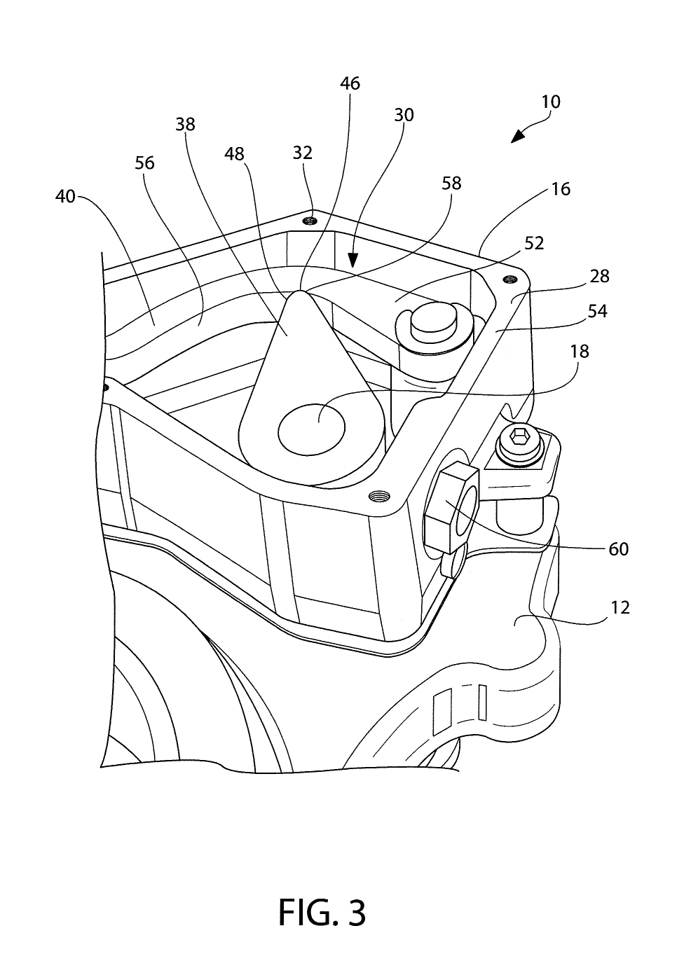

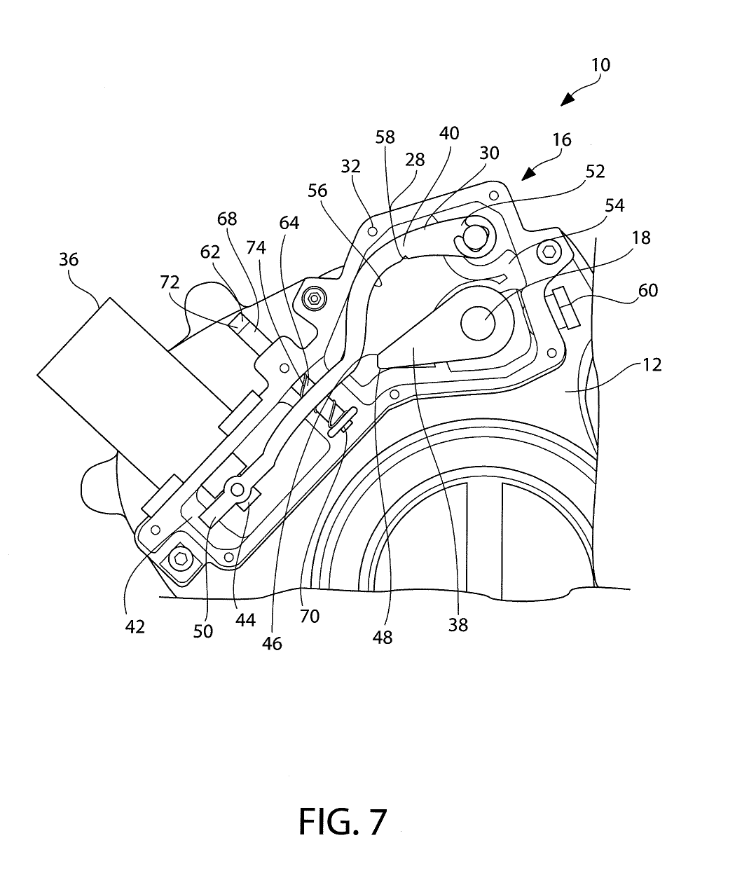

The trigger assembly 30 is for securing shaft 18 such that the swing gate 14 is held in its open position (see FIG. 4) and for triggering the shaft 18 to rotate due to biasing from the spring 22 to cause the swing gate 14 to move from the open position to the closed position. The trigger assembly 30 generally includes an actuator 36 (preferably linear), a pivotable cam 38, and a trigger rocker arm 40 (see FIGS. 3, 5 and 7). The actuator 36 is disposed at a first end 42 of the actuation housing 28 and has an actuator shaft 44. The pivotable cam 38 is disposed in the actuation housing 28 and is disposed on the pivotable shaft 18 such that rotation of the pivotable cam 38 causes rotation of the pivotable shaft 18. The pivotable cam 38 also has a sear point 46 and a cam contact surface 48. The trigger rocker arm 40 is disposed in the actuation housing 28 and has a first end 50 pivotally attached to actuator shaft 44 of the actuator 36, a second end 52 pivotally attached to a second end 54 of the actuation housing 28, and a curved cam surface 56 adjacent to the second end 52 of the trigger rocker arm 40. The curved cam surface 56 has a notch 58 (best seen in FIG. 7) to receive the sear point 46 of the cam 38. The cam surface 56 of the trigger rocker arm 40 is for contacting the cam contact surface 48 of the cam 38 such that rotational movement of the reset handle 20 against the bias of the spring 22 causes the cam contact surface 48 of the pivotable cam 38 to follow the cam surface 56 of the trigger rocker arm 40 to cause the rocker arm 40 to rotate about its second end 52 to a position when the sear point 46 is received in the notch 58. See FIGS. 1, 2, 4 and 6.

Actuation of the actuator 36 to cause (preferably, but not limited to, linear) movement of the actuator shaft 44 causes the first end 50 of the rocker arm 40 to move such that the rocker arm 40 pivots about the second end 52 of the rocker arm 40 away from the cam 38 such that the sear point 46 of the cam 38 is released from notch 58 of the rocker arm 40, thereby allowing the spring 22 to cause the pivotable shaft 18 to rotate about its longitudinal axis to move the swing gate to its closed position.

The actuator 36 may be of substantially any type. It is preferably a linear actuator, but any actuator or solenoid or similar device that provides an appropriate movement of the rocker arm 40 is considered to be within the scope of the present invention. For example, mechanical, electro-mechanical, solenoid, hydraulic, pneumatic, and piezo actuators could all work appropriately.

A switch 60 may be provided that is connected to a display to indicate when the swing gate 14 is in its open and closed positions. The switch 60 may be, for example, adjacent to the cam 38 wherein rotation of the cam 38 activates and deactivates the switch 60. The switch 60 may be, for example, an electro-magnetic switch, a mechanical switch or Hall-effect switch.

A manual override device 62 may be provided to trip the trigger assembly 30 to manually cause the swing gate 14 to move to the closed position to block air to the engine. The manual override device 62 includes an override device shaft 64 slidably disposed in an aperture in the actuator housing 28 adjacent to the actuator 36. The override device shaft 64 is substantially parallel to an axis of movement of the actuator shaft 44. The override device shaft 64 has a first end 68 and a second end 70. The first end 68 is disposed outside the actuator housing 28 and has a handle 72 for manual movement of the override device shaft 64 through the aperture. The second end 70 is disposed adjacent to the first end 50 of the rocker arm 40 such that manual movement of the override device shaft 64 causes substantially identical movement of the rocker arm 40 as the movement caused by the actuator shaft 44. The manual override device 62 may be biased by a spring 74 to a position where it does not contact the rocker arm 40.

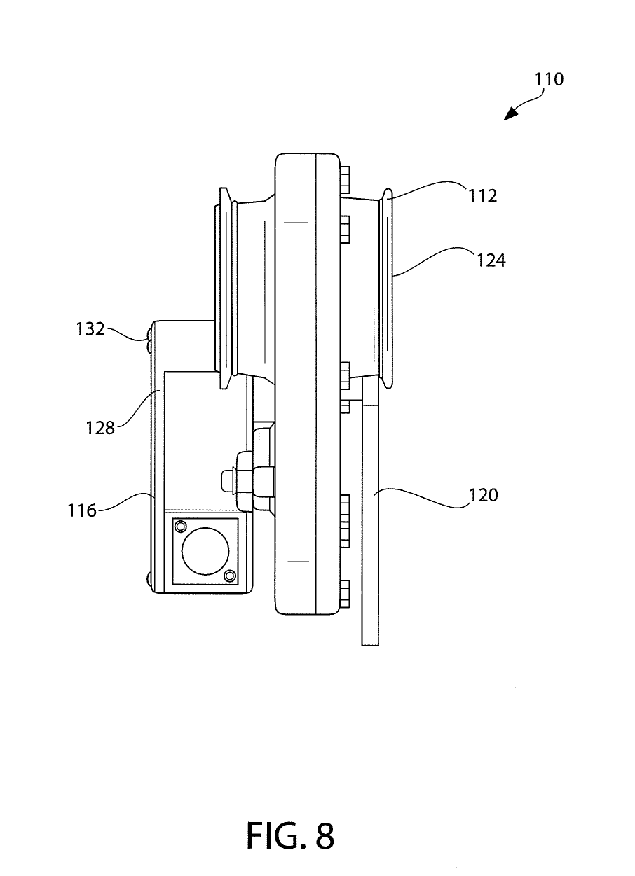

There is shown in FIGS. 8-13 an air shutoff swing gate valve 110 for an engine in accordance with a second preferred embodiment of the present invention. The air shutoff swing gate valve 110 generally includes a valve body 112, a valve swing gate 114, an actuation assembly 116, a pivotable shaft 118, a reset handle 120, and a spring 122.

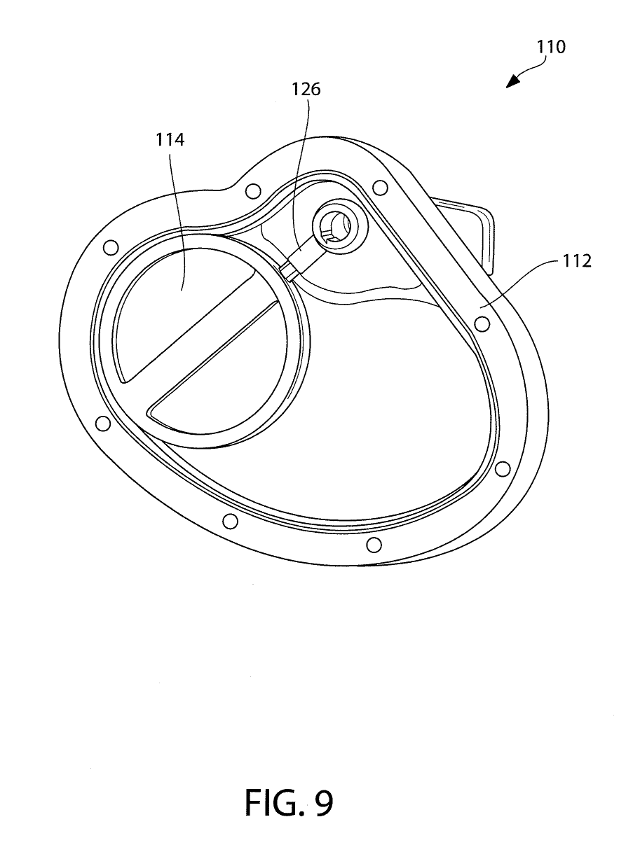

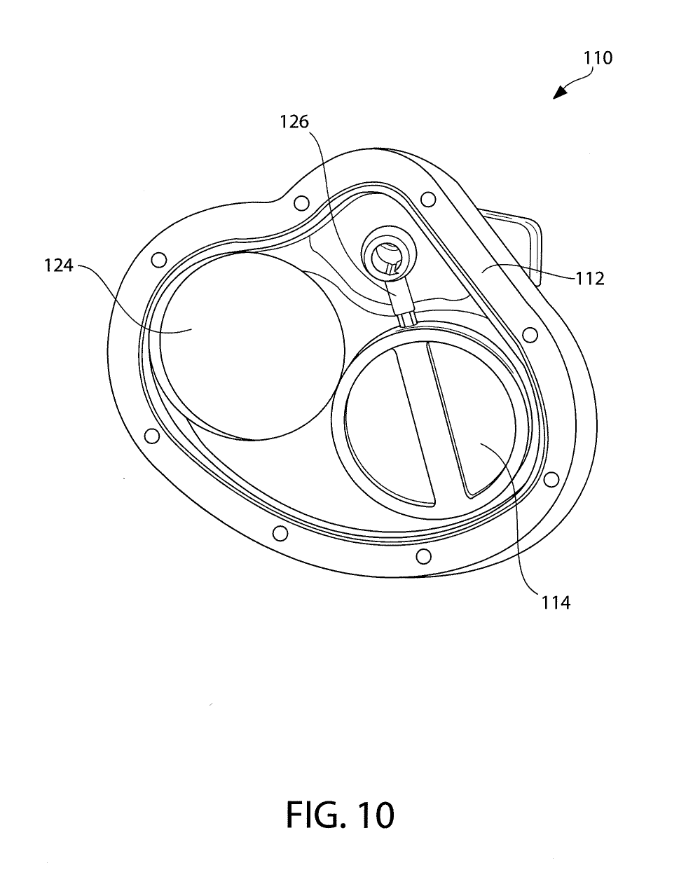

The valve body 112 has an air passage 124 therein for supplying air to an engine to which the air shutoff valve 110 is attached. The swing gate 114 is pivotable on a swing arm 126 that is pivotally disposed adjacent to the valve body 112. The swing gate 14 is pivotable from an open position (see FIG. 10) wherein the swing gate 114 is positioned adjacent to the air passage 124 to provide for free flow of air through the air passage 124, to a closed position (see FIG. 9) wherein the swing gate 114 is positioned within the air passage 124 to substantially close off the air passage 124. The actuation assembly 116 includes an actuation housing 128 and a trigger assembly 130. The actuation housing 128 is preferably disposed on the valve body 112 by fasteners 132.

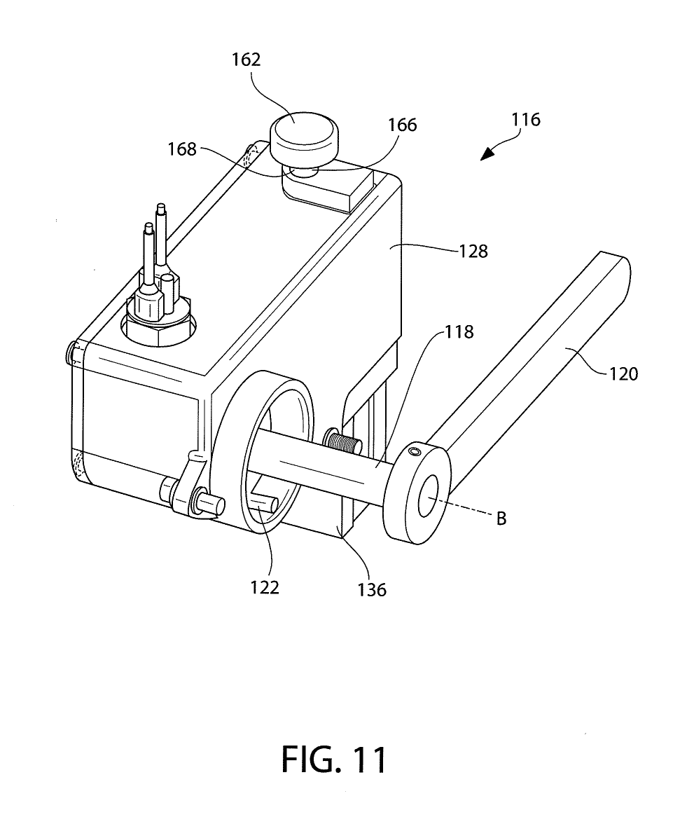

A pivotable shaft 118 has a longitudinal axis B (see FIG. 11) and extends from the actuation assembly 116 at least to the swing arm 126. The swing arm 126 is disposed on the shaft 118 such that rotation of the shaft 118 about its longitudinal axis B causes rotation of the swing arm 126 to move the swing gate 114 between its open (see FIG. 10) and closed positions (see FIG. 9). The reset handle 120 is disposed on the shaft 118 such that rotation of the reset handle 120 to rotate the shaft 118 causes the swing gate 114 to move from its closed position to its open position. The spring 122 rotationally biases the shaft 118 about its longitudinal axis B to urge the swing gate 114 toward its closed position (see FIG. 9).

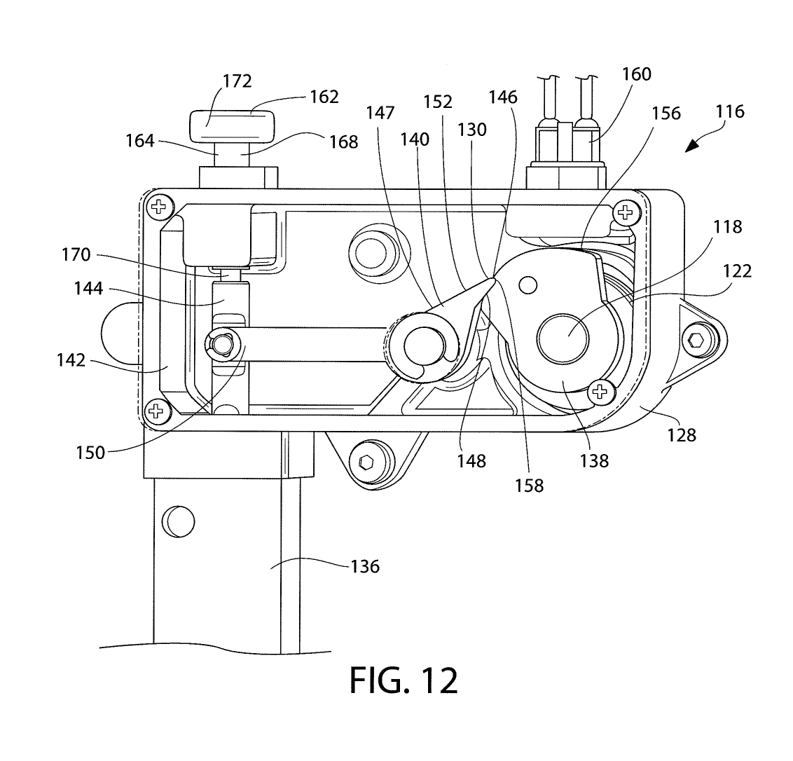

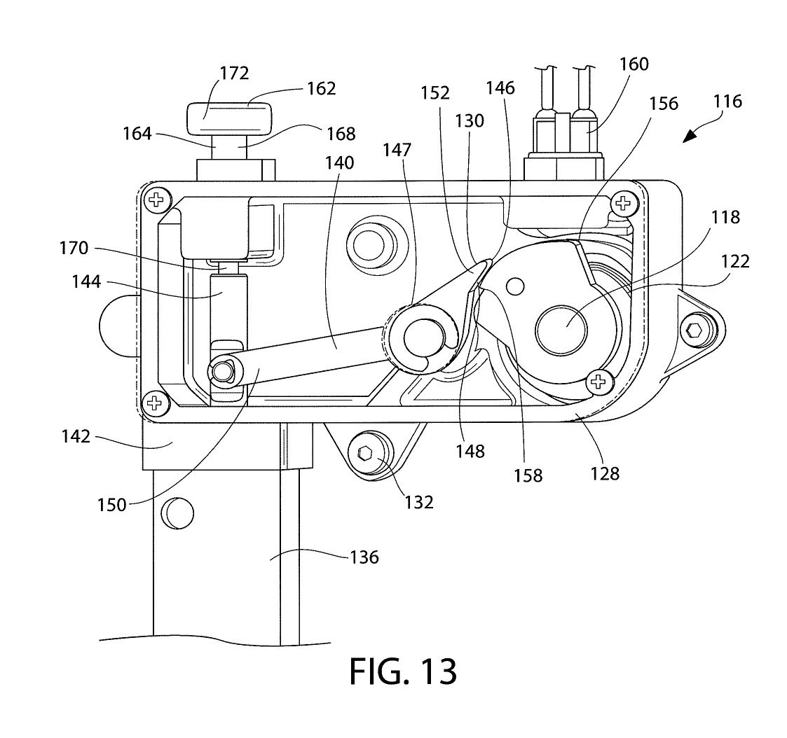

The trigger assembly 130 is for securing shaft 118 such that the swing gate 114 is held in its open position (see FIG. 10) and for triggering the shaft 118 to rotate due to biasing from the spring 122 to cause the swing gate 114 to move from the open position to the closed position (see FIG. 9). As can best be seen in FIGS. 12 and 13, the trigger assembly 130 generally includes an actuator 136 (preferably linear), a pivotable cam 138, and a trigger rocker arm 140. The actuator 136 is disposed at a first end 142 of the actuation housing 128 and has an actuator shaft 144. The pivotable cam 138 is disposed in the actuation housing 128 and is disposed on the pivotable shaft 118 such that rotation of the pivotable cam 138 causes rotation of the pivotable shaft 118. The pivotable cam 138 also has a notch 158 and a cam surface 156. The trigger rocker arm 140 is disposed in the actuation housing 128 and has a first end 150 pivotally attached to actuator shaft 144 of the actuator 136. The trigger rocker arm 140 also has a central portion 147 pivotally attached to the actuation housing 128 between the pivotable cam 138 and the actuator 136. Finally, the trigger rocker arm has the sear point 146 and the cam contact surface 148 at its second end 152. The sear point 146 is for receipt in the notch 158 of the cam 138. The cam surface 156 of the pivotable cam 138 is for contacting the cam contact surface 148 of the trigger rocker arm 140 such that manual rotational movement of the reset handle 120 against the bias of the spring 122 causes the cam contact surface 148 of the trigger rocker arm 140 to follow the cam surface 156 of the pivotable cam 138 to cause the rocker arm 140 to rotate about its central portion 147 to a position until the sear point 146 is received and held in the notch 158.

Actuation of the actuator 136 to cause linear movement of the actuator shaft 144 causes the first end 150 of the rocker arm 140 to move such that the rocker arm 140 pivots about the central portion 147 of the rocker arm 140 to cause the second end 152 of the rocker arm 140 to rotate away from the notch 158 such that the sear point 146 of the trigger rocker arm 140 is released from notch 158 of the cam 138, wherein the spring 122 causes the shaft 118 to rotate about its longitudinal axis B to move the swing gate 114 to its closed position.

Again, the actuator 136 may be of substantially any type. It is preferably a linear actuator, but any actuator or solenoid or similar device that provides an appropriate movement of the rocker arm 140 is considered to be within the scope of the present invention. For example, mechanical, electro-mechanical, hydraulic, pneumatic, and piezo actuators could all work appropriately.

A switch 160 may be provided that is connected to a display to indicate when the swing gate 114 is in its open and closed positions. The switch 160 may be adjacent to the cam 138 wherein rotation of the cam 138 activates and deactivates the switch 160. The switch 160 may be, for example, an electromagnetic switch, a mechanical switch, or Hall-effect switch.

A manual override device 162 may be provided to trip the trigger assembly 130 to provide for manual tripping of the swing gate 114 to move it to the closed position to block air to the engine. The manual override device 162 includes an override device shaft 164 slidably disposed in an aperture in the actuator housing 128 adjacent to the actuator 136. The override device shaft 164 is coaxial with the actuator shaft 144. The override device shaft 164 has a first end 168 and a second end 170. The first end 168 is disposed outside the actuator housing 128 and has a handle 172 (or button or any portion available to manually grip) for manual movement of the override device shaft 164 through the aperture. The second end 170 is disposed on the actuator shaft 144 such that manual movement of the override device shaft 144 causes substantially identical movement of the rocker arm 140 as the movement caused by the actuator shaft 144.

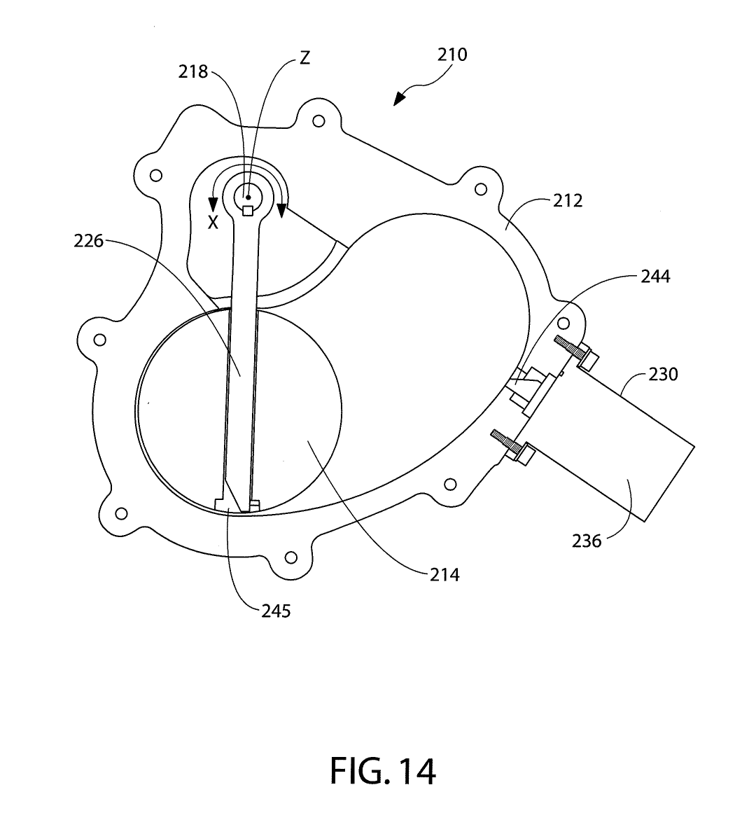

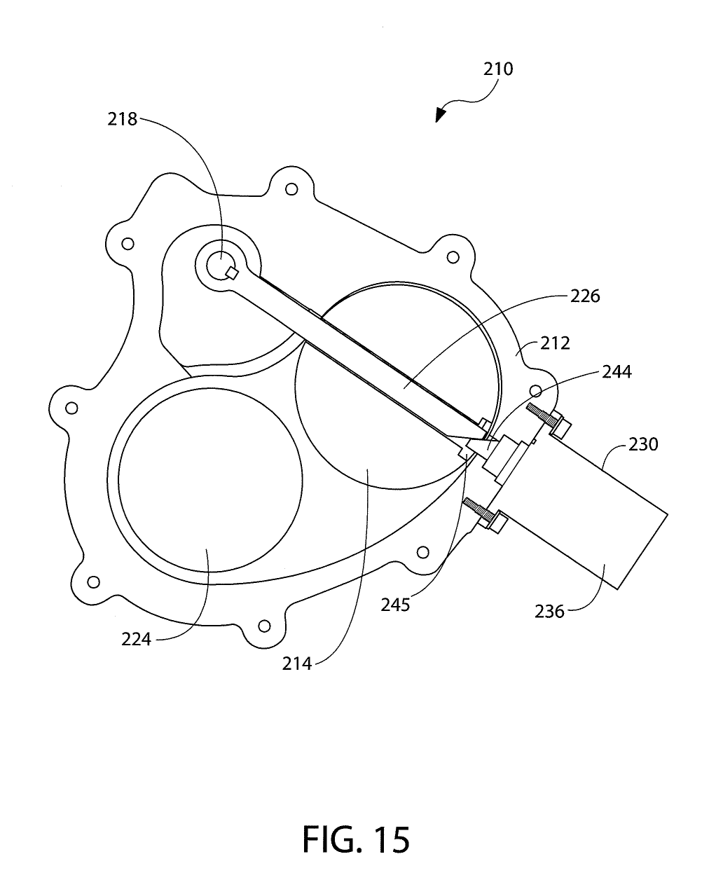

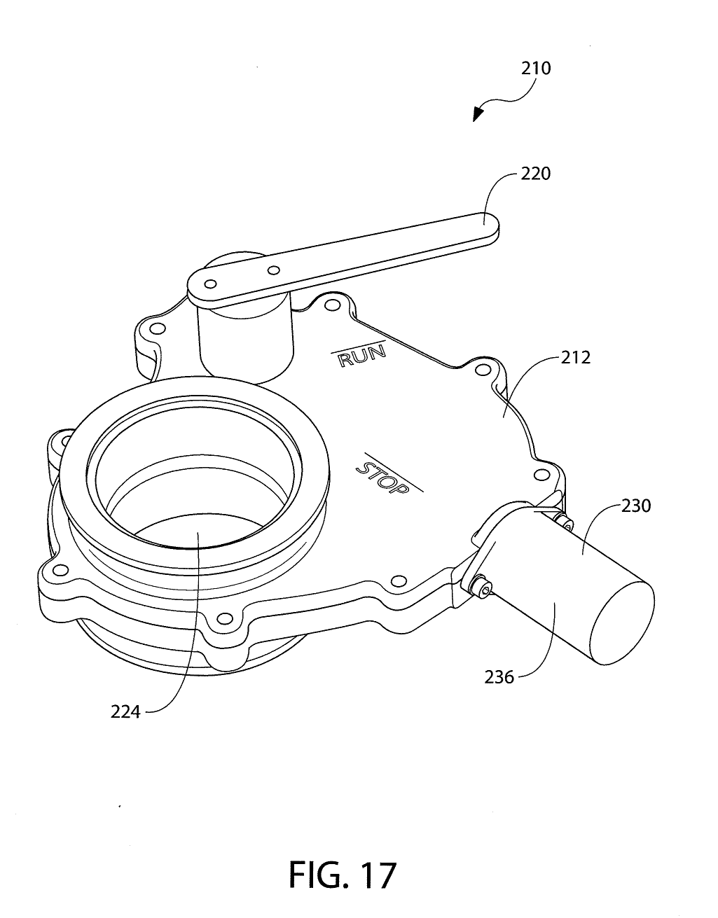

There is shown in FIGS. 14-17 an air shutoff swing gate valve 210, for, for example, an engine, in accordance with a third preferred embodiment of the present invention. The air shutoff swing gate valve 210 generally includes a valve body 212, a valve swing gate 214, a trigger assembly 230, a pivotable shaft 218, a reset handle 220 (see FIG. 17), and a spring (not shown, but similar to previous embodiments). The valve body 212 has an air passage 224 therein for supplying air to, for example, an engine. The valve swing gate 214 is pivotable on a swing arm 226 that is pivotally disposed on the valve body 212. The swing gate 214 is pivotable adjacent to the air passage 224 from an open position wherein the swing gate 214 is positioned adjacent to the air passage 224 to provide for free flow of air through the air passage 224 (see FIG. 15), to a closed position wherein the swing gate 214 is positioned within the air passage 224 to substantially close off the air passage 224 (see FIG. 14). The pivotable shaft 218 has a longitudinal axis Z (perpendicular to the page in FIGS. 14-16). The pivotable shaft 218 extends perpendicular to the swing arm 226. The swing arm 226 is disposed on the pivotable shaft 218 such that rotation of the pivotable shaft 218 about its longitudinal axis Z (in directions of arc X, see FIG. 14) causes rotation of the swing arm 226 to move the swing gate 214 between its open and closed positions. The reset handle 220 is disposed on the pivotable shaft 218, such that rotation of the reset handle 220 to rotate the shaft 218 causes the swing gate 214 to move from its closed position (see FIG. 15) to its open position (see FIG. 14). The spring, for example, a torsion spring, is provided to rotationally bias the shaft 218 about its longitudinal axis to urge the swing gate 214 toward its closed position.

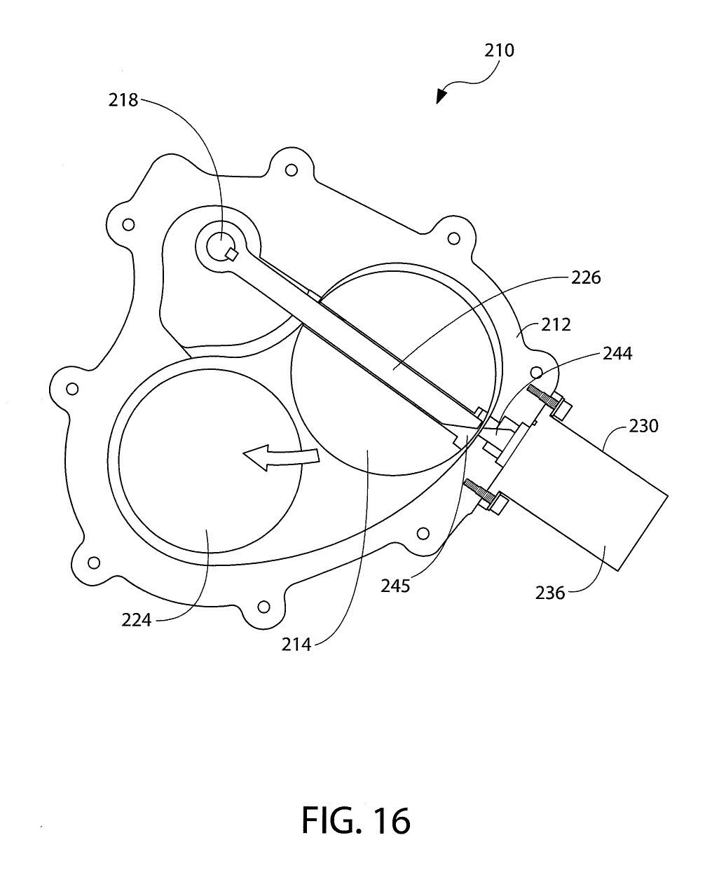

The trigger assembly 230 is provided for securing the swing gate 214 in its open position (see FIG. 15) and for triggering the shaft 218 to rotate due to biasing from the spring to cause the swing gate 214 to move from the open position to the closed position. The trigger assembly 230 includes an actuator 236 having an actuator shaft 244 movable from an extended position (see FIG. 15) to a retracted position (see FIGS. 14 and 16). The actuator shaft 244 is received in a receiver 245, for example, an aperture, in the swing arm 226. When the actuator shaft 244 is in the extended position, the actuator shaft 244 is disposed in the receiver 245 and the swing gate 224 is locked in its open position. Actuation (or de-actuation) of the actuator 236 causes the actuator shaft 244 to withdraw to its retracted position out of the receiver 245, thereby causing the spring to rotate the pivotable shaft 218 about its longitudinal axis to move the swing gate 224 to its closed position.

Again, as in the previous embodiments, the actuator may be, for example, mechanical, electro-mechanical, hydraulic, pneumatic, piezo, or a solenoid. The actuator 236 may be disposed such that its actuator shaft 244 is generally parallel to the swing arm 226 when the swing gate 214 is in its open and locked position such that the actuator shaft 244 is disposed against/in the receiver 245 on the swing arm 226 to hold the swing gate 214 in the open position.

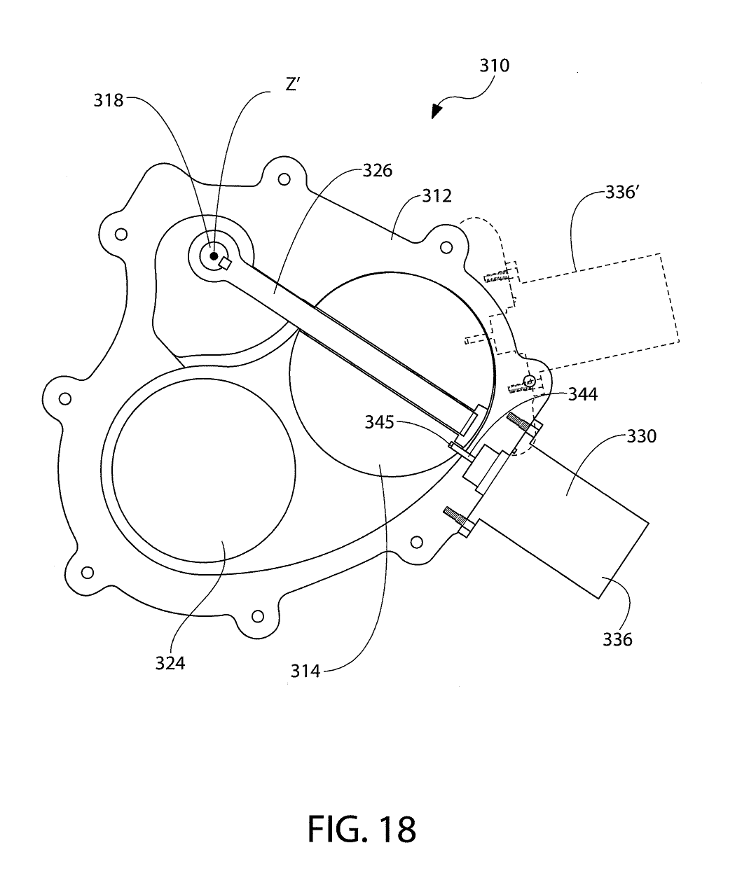

There is shown in FIG. 18 an air shutoff swing gate valve 310 for, for example, an engine in accordance with a fourth preferred embodiment of the present invention. The air shutoff swing gate valve 310 generally includes a valve body 312, a valve swing gate 314, a trigger assembly 330, a pivotable shaft 318, a reset handle (not shown, but similar to that shown in previous embodiments), and a spring (not shown, but similar to that shown in previous embodiments). The valve body 312 has an air passage 324 therein for supplying air. The valve swing gate 314 is pivotable on a swing arm 326 that is pivotally disposed on the valve body 312. The swing gate 314 is pivotable adjacent to the air passage 324 from an open position wherein the swing gate 314 is positioned adjacent to the air passage to provide for free flow of air through the air passage 324 (shown), to a closed position wherein the swing gate 314 is positioned within the air passage 324 to substantially close off the air passage 324 (similar to that shown in FIG. 14). The pivotable shaft 318 has a longitudinal axis Z′ (perpendicular to the page in FIG. 18). The pivotable shaft 318 extends to the swing arm 326. The swing arm 326 is disposed on the pivotable shaft 318 such that rotation of the pivotable shaft 318 about its longitudinal axis causes rotation of the swing arm 326 to move the swing gate 314 between its open and closed positions. The reset handle is disposed on the pivotable shaft 318, such that rotation of the reset handle to rotate the shaft 318 causes the swing gate 314 to move from its closed position to its open position. The spring, for example, a torsion spring, is provided to rotationally bias the shaft 318 about its longitudinal axis to urge the swing gate 314 toward its closed position. The trigger assembly 330 is provided for securing the swing gate 314 in its open position and for triggering the shaft 318 to rotate due to biasing from the spring to cause the swing gate 314 to move from the open position to the closed position. The trigger assembly 330 includes an actuator 336 having an actuator shaft 344 movable from an extended position to a retracted position. The actuator shaft 344 is received in a receiver 345, for example, an aperture, in the swing arm 326 or the swing gate 324. As can be seen in the example in broken lines in FIG. 18, the actuator 336, 336′ may be situated on the valve body 312 in any suitable location.

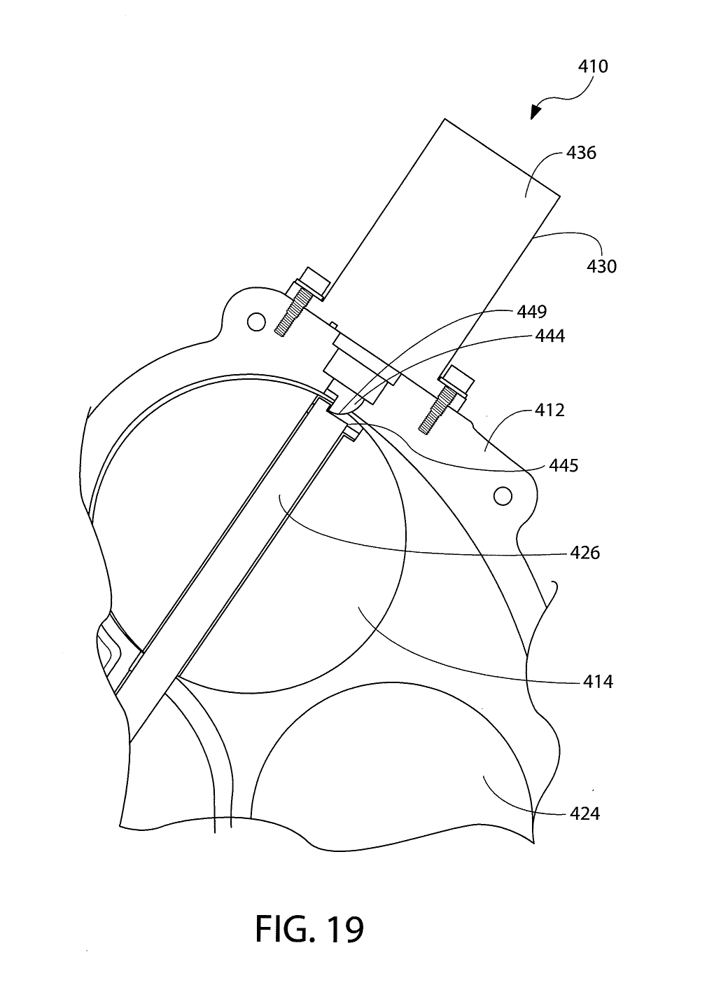

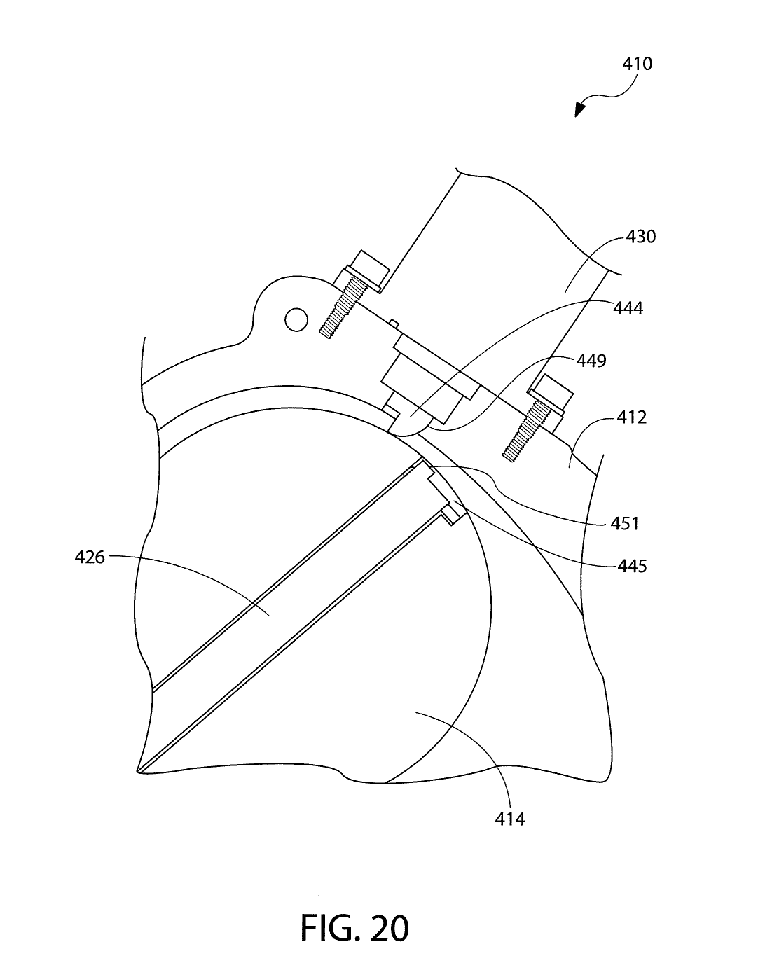

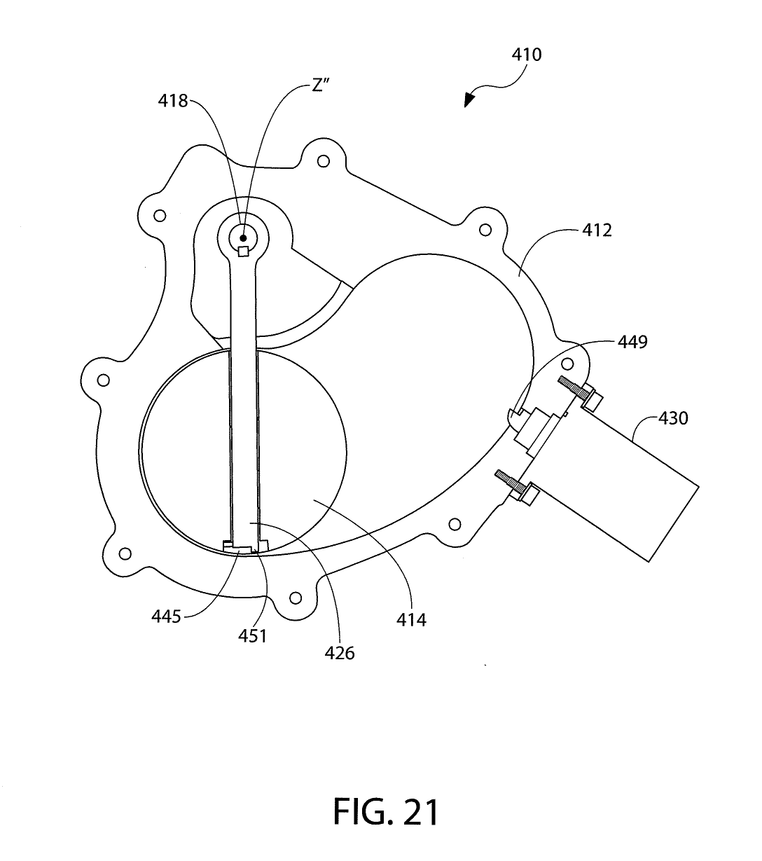

There is shown in FIGS. 19-21 an air shutoff swing gate valve 410 for an engine in accordance with a fifth preferred embodiment of the present invention. The air shutoff swing gate valve 410 generally includes a valve body 412, a valve swing gate 414, a trigger assembly 430, a pivotable shaft 418, a reset handle (not shown, but similar to that shown in previous embodiments), and a spring (not shown, but similar to that shown in previous embodiments). The valve body 412 has an air passage 424 therein for supplying air. The valve swing gate 414 is pivotable on a swing arm 426 that is pivotally disposed on the valve body 412. The swing gate 414 is pivotable adjacent to the air passage 424 from an open position wherein the swing gate 414 is positioned adjacent to the air passage 424 to provide for free flow of air through the air passage 424 (see FIG. 21), to a closed position wherein the swing gate 414 is positioned within the air passage 424 to substantially close off the air passage 424 (see FIG. 19). The pivotable shaft 418 has a longitudinal axis Z″ (perpendicular to the page in FIG. 21). The pivotable shaft 418 extends to the swing arm 426. The swing arm 426 is disposed on the pivotable shaft 418 such that rotation of the pivotable shaft 418 about its longitudinal axis causes rotation of the swing arm 426, to move the swing gate 414 between its open and closed positions. The reset handle is disposed on the pivotable shaft 418, such that rotation of the reset handle to rotate the shaft 418 causes the swing gate 414 to move from its closed position to its open position. The spring, for example, a torsion spring, is provided to rotationally bias the shaft 418 about its longitudinal axis to urge the swing gate 414 toward its closed position. The trigger assembly 430 is provided for securing the swing gate 414 in its open position and for triggering the shaft 418 to rotate due to biasing from the spring to cause the swing gate 414 to move from the open position to the closed position. The trigger assembly 430 includes an actuator 436 having an actuator shaft 444 movable from an extended position (see FIG. 19) to a retracted position (see FIG. 20). The actuator shaft 444 is received in a receiver 445, for example, an aperture (or notch), in the swing arm 426 to receive the actuator shaft 444. As shown in this embodiment, the actuator shaft 444 may have a cam surface 449 adapted to mate with a cam surface 451 of the receiver 445.

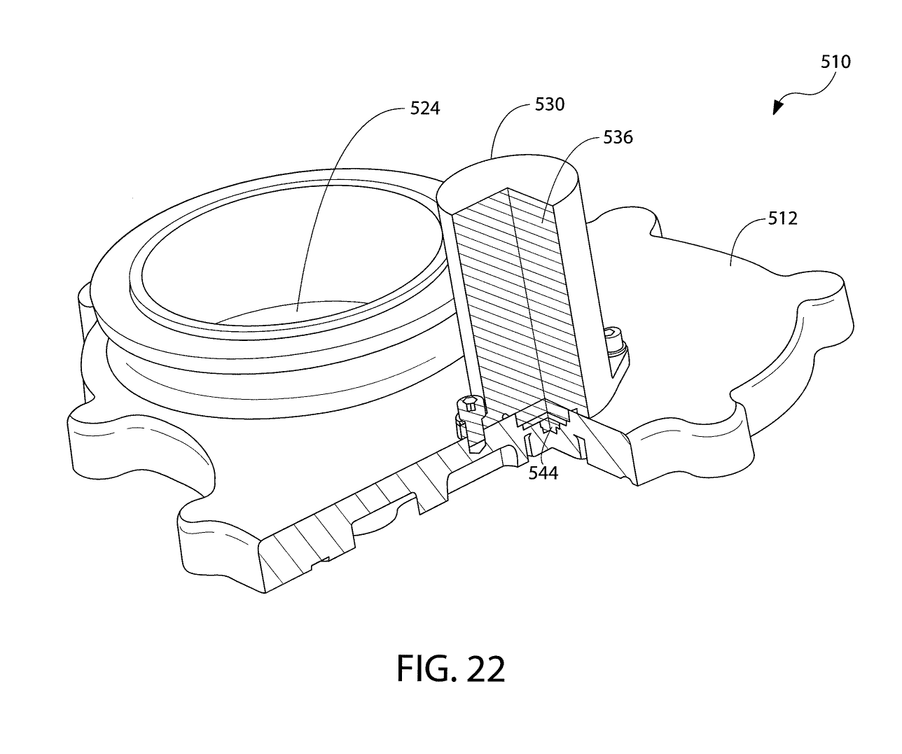

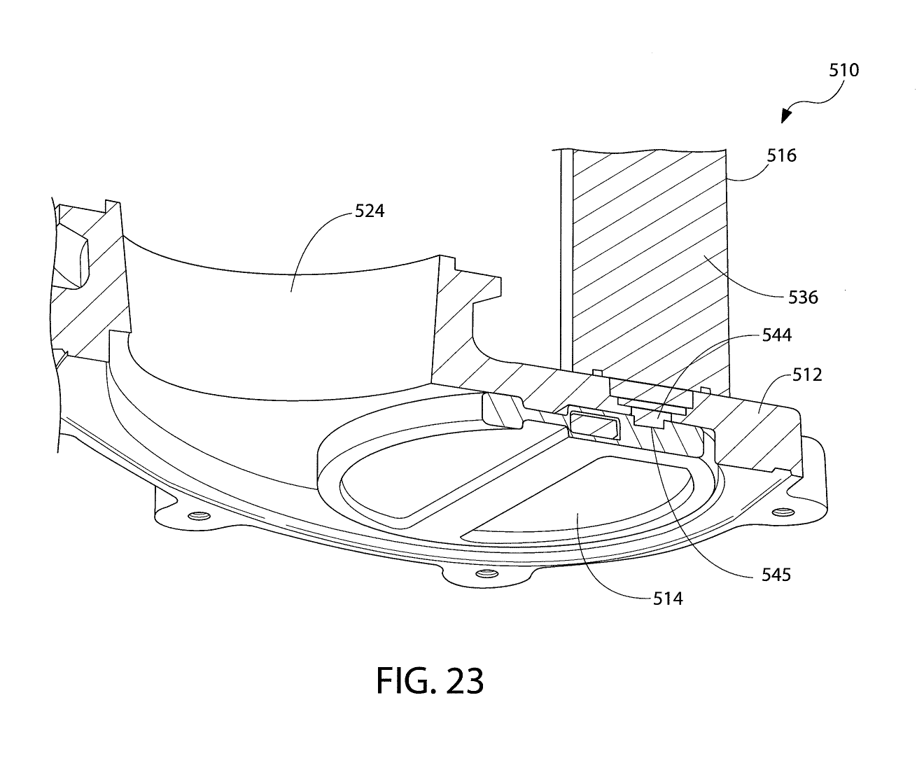

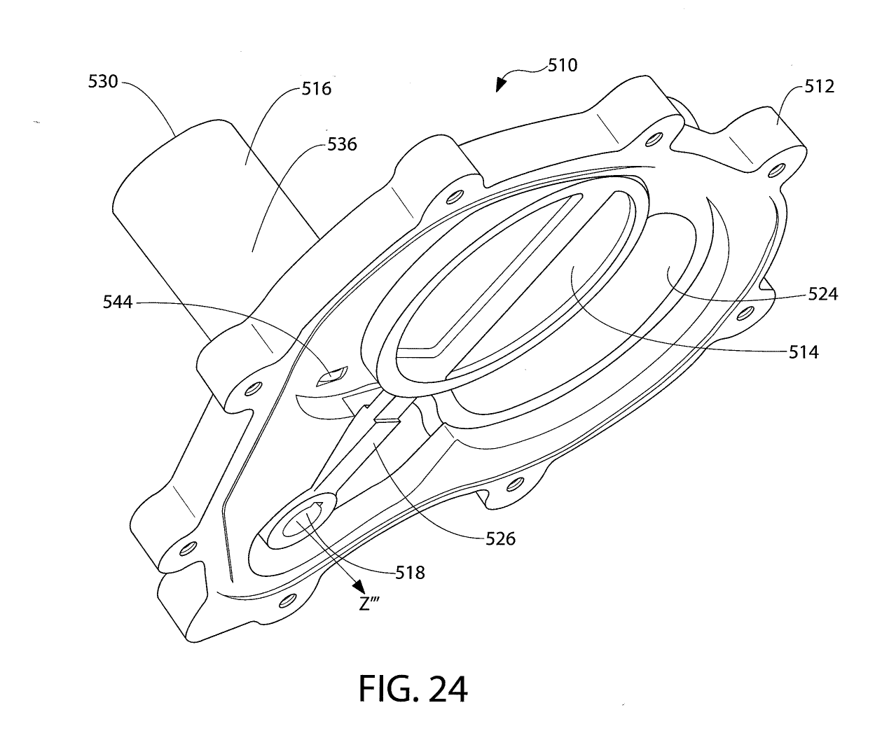

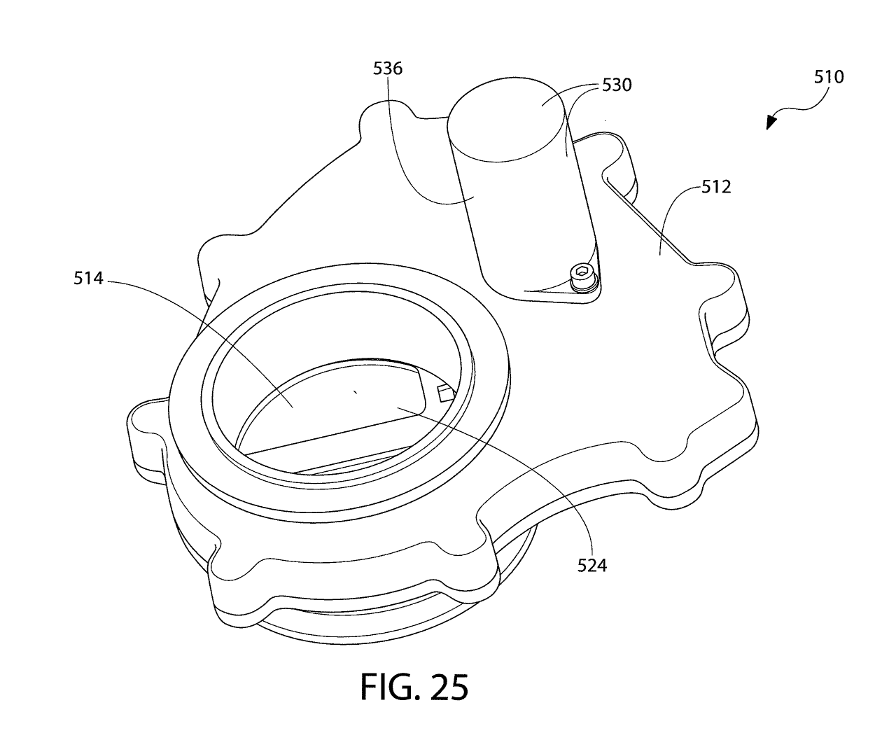

Finally, there is shown in FIGS. 22-25 an air shutoff swing gate valve 510 for an engine in accordance with a sixth preferred embodiment of the present invention. The air shutoff swing gate valve 510 generally includes a valve body 512, a valve swing gate 514, a trigger assembly 530, a pivotable shaft 518, a reset handle (not shown, but similar to that shown in previous embodiments), and a spring (not shown, but similar to that shown in previous embodiments). The valve body 512 has an air passage 524 therein, the air passage for supplying air. The valve swing gate 514 is pivotable on a swing arm 526 that is pivotally disposed on the valve body 512. The swing gate 514 is pivotable adjacent to the air passage 524 from an open position wherein the swing gate 514 is positioned adjacent to the air passage to provide for free flow of air through the air passage 524 (see FIGS. 22 and 23), to a closed position wherein the swing gate 514 is positioned within the air passage 524 to substantially close off the air passage 524 (similar to that shown in FIG. 14). The pivotable shaft 518 has a longitudinal axis Z′″ (see FIG. 24). The pivotable shaft 518 extends to the swing arm 526. The swing arm 526 is disposed on the pivotable shaft 518 such that rotation of the pivotable shaft 518 about its longitudinal axis causes rotation of the swing arm 526, to move the swing gate 514 between its open and closed positions. The reset handle is disposed on the pivotable shaft 518, such that rotation of the reset handle to rotate the shaft 518 causes the swing gate 514 to move from its closed position to its open position. The spring, for example, a torsion spring, is provided to rotationally bias the shaft 518 about its longitudinal axis to urge the swing gate 514 toward its closed position. The trigger assembly 530 is provided for securing the swing gate 514 in its open position and for triggering the shaft 518 to rotate due to biasing from the spring to cause the swing gate 514 to move from the open position to the closed position. The trigger assembly 530 includes an actuator 536 having an actuator shaft 544 movable from an extended position to a retracted position. The actuator shaft 544 is received in a receiver 545, for example, an aperture, in the swing arm 526 or the swing gate 524. Here, the actuator 536 is disposed such that its actuator shaft 544 is generally perpendicular to the swing gate 514 such that the actuator shaft 544 is disposed against the receiver 545 on the swing gate 524 (or swing arm 526) to hold the swing gate 524 in the open position.

With respect to all embodiments, preferably, the valve body 12, 112, 312, 412, 512 is aluminum, but any suitable material may be used. Preferably, Marmon flanges may be used to connect the valve 10, 110, 210, 310, 410, 510 to the engine, however, any suitable flange or hose connection may be used. Preferably, the gate is manufactured from bronze alloy or composite material.

The present invention operates in either “hard installations,” such as integral with aluminum piping, or “soft installations,” such as along rubber hoses. Each of the improvements described herein helps the valve to operate in high vibration and temperature environments.

While the present invention has been described primarily with respect to an engine, such as a diesel engine, the present invention is not intended to be limited only to engines. It is intended to apply to substantially any application where a cutoff valve could be used, even including, for example, a water cutoff supply.

While the invention has been described in detail and with reference to specific embodiments thereof, it will be apparent to one skilled in the art that various changes and modifications can be made therein without departing from the spirit and scope thereof.

What is claimed is:

1. An air shutoff swing gate valve, comprising:
(a) a valve body having an air passage therein, the air passage for supplying air;
(b) a valve swing gate, pivotable on a swing arm that is pivotally disposed adjacent to the valve body, the swing gate pivotable adjacent to the air passage from an open position wherein the swing gate is positioned adjacent to the air passage to provide for free flow of air through the air passage, to a closed position wherein the swing gate is positioned within the air passage to substantially close off the air passage;
(c) a pivotable shaft having a longitudinal axis, the shaft extending generally perpendicular to the swing arm, the swing arm disposed on the shaft such that rotation of the shaft about its longitudinal axis causes rotation of the swing arm, to move the swing gate between its open and closed positions;
(d) a reset handle disposed on the shaft, such that rotation of the reset handle to rotate the shaft causes the swing gate to move from its closed position to its open position;
(e) a spring to rotationally bias the shaft about its longitudinal axis to urge the swing gate toward its closed position;
(f) a trigger assembly for securing the swing gate in its open position and for triggering the shaft to rotate due to biasing from the spring to cause the swing gate to move from the open position to the closed position, the trigger assembly comprising:
(i) an actuator having an actuator shaft movable from an extended position to a retracted position; and
(ii) a receiver in one of the swing arm and the swing gate to receive the actuator shaft; and
(g) wherein when the actuator shaft is in the extended position, the actuator shaft is disposed in the receiver and the swing gate is locked in its open position, and wherein actuation of the actuator causes the actuator shaft to withdraw to its retracted position out of the receiver, wherein the spring causes the pivotable shaft to rotate about its longitudinal axis to move the swing gate to its closed position.

2. The air shutoff swing gate valve of claim 1, wherein the actuator is of a type selected from the group consisting of mechanical, electro-mechanical, hydraulic, pneumatic, and piezo.

3. The air shutoff swing gate valve of claim 1, wherein the actuator is a solenoid.

4. The air shutoff swing gate valve of claim 1, wherein the actuator is disposed such that its actuator shaft is generally parallel to the swing arm when the swing gate is in its open and locked position such that the actuator shaft is disposed against the receiver on the swing arm to hold the swing gate in the open position.

5. The air shutoff swing gate valve of claim 1, wherein the actuator shaft of the swing arm has a cam surface adapted to mate with a cam surface of the receiver.

6. The air shutoff swing gate valve of claim 1, wherein the receiver is an aperture in the swing gate, and wherein when the actuator shaft is in its extended position, the actuator shaft is disposed in the aperture to hold the swing gate in its open position.

7. The air shutoff swing gate valve of claim 1, wherein the actuator is disposed such that its actuator shaft is generally perpendicular to the swing gate such that the actuator shaft is disposed against the receiver on the swing gate to hold the swing gate in the open position.

8. In an air shutoff swing gate valve having a valve body, a valve swing gate pivotable from an open position to provide for free flow of air through the air passage to a closed position to substantially close off the air passage, a pivotable shaft disposed as a pivot point on the swing arm, a reset handle to rotate the shaft to cause the swing gate to move from its closed position to its open position, a spring to rotationally bias the shaft about its longitudinal axis to urge the swing gate toward its closed position, a trigger assembly for securing the shaft such that the swing gate is held in its open position and for triggering the shaft to rotate due to biasing from the spring to cause the swing gate to move from the open position to the closed position, the trigger assembly comprising:
(a) an actuator having an actuator shaft movable from an extended position to a retracted position; and
(b) a receiver on one of the swing gate and the swing gate arm to receive the actuator shaft;
wherein when the actuator shaft is in the extended position, the actuator shaft is disposed on the receiver and the swing gate is locked in its open position, and wherein actuation of the actuator causes the actuator shaft to withdraw to its retracted position from the receive, wherein the spring causes the pivotable shaft to rotate about its longitudinal axis to move the swing gate to its closed position.

9. The air shutoff swing gate valve of claim 8, wherein the actuator is of a type selected from the group consisting of mechanical, electro-mechanical, hydraulic, pneumatic, and piezo.

10. The air shutoff swing gate valve of claim 8, wherein the actuator is a solenoid.

11. The air shutoff swing gate valve of claim 8, wherein the actuator is disposed such that its actuator shaft is generally parallel to the swing arm when the swing gate is in its open and locked position such that the actuator shaft is disposed against the receiver on the swing arm to hold the swing gate in the open position.

12. The air shutoff swing gate valve of claim 8, wherein the actuator shaft of the swing arm has a cam surface adapted to mate with a cam surface of the receiver.

13. The air shutoff swing gate valve of claim 8, wherein the receiver is an aperture in the swing gate, and wherein when the actuator shaft is in its extended position, the actuator shaft is disposed in the aperture to hold the swing gate in its open position.

14. The air shutoff swing gate valve of claim 8, wherein the actuator is disposed such that its actuator shaft is generally perpendicular to the swing gate such that the actuator shaft is disposed against the receiver on the swing gate to hold the swing gate in the open position.
